(19) United States
(12) Patent Application Publication
(10) Pub. No.: US 2015/0215780 A1
(43) Pub. Date: Jul. 30, 2015

(54) Method and device for transmitting data

(71) Applicant: ZTE Corporation, Shenzhen, GD (CN)

(72) Inventors: Yifeng Bi, Shenzhen (CN); Jianjie You, Shenzhen (CN); Xiaoyun Zhou, Shenzhen (CN)

(73) Assignee: ZTE Corporation, Shenzhen, GD (CN)

(21) Appl. No.: 14/417,124

(22) PCT Filed: Jul. 25, 2013
(86) PCT No.: PCT/CN2013/080142

§ 371 Date: Jan. 23, 2015

(30) Foreign Application Priority Data
Jul. 25, 2012 (CN) 201210259527.7

(51) Int. Cl. H04W 12/06; H04W 84/12; H04L 29/06

(52) U.S. Cl. CPC H04W 12/06; H04L 63/0892; H04W 84/12

(57) ABSTRACT

A method and device for data transmission are provided. The method includes: a TWAG receives a fixed network gateway identity transmitted by a fixed network gateway; and, the TWAG transmits to the fixed network gateway, on the basis of the fixed network gateway identity, a downlink data packet that P-GW transmitted to the TWAG. The present invention implements correct routing and forwarding of a downlink data service, thus allowing for the achievement of the effect that smooth deployment of a terminal UE service is ensured.

### TECHNICAL FIELD

The present invention relates to the field of communications, and in particular, to a method and device for transmitting data.

### BACKGROUND

With the development of network technologies and users' requirements for the services, the terminals gradually become multi-modelling and can select to access to the access networks of different types so as to bear diversified services. Different network connections have different properties and transmission capabilities, thus the users' requirements for multi-service and diversity can be better satisfied. Multi-mode terminals can realise seamless connections between different types of wireless access networks, for example, the connection between a 3GPP (3^{rd} Generation Partnership Project) EPS (Evolved Packet System) and an IEEE (Institute of Electrical and Electronics Engineers) 802.11 WLAN (Wireless Local Area Networks). A WLAN can provide a very high data speed in a small-scale family and hot area, while a cellular network can provide a higher flexibility and ubiquitous coverage, but the data speed thereof is lower. If the advantages of the two could be combined, the users will benefit therefrom. Within a coverage range of a WLAN access point, the multi-mode terminal performs data access and VoIP (Voice over Internet Protocol, network telephone) application using the WLAN, and at the same time can also use an overlapped cellular network to perform voice calling or media access.

At present, BBF (Broadband Forum) and 3GPP are working on the standardization of FMC (Fixed Mobile Convergence), and the scenarios related to include the authentication, address allocation and strategy control of a 3GPP UE (User Equipment) accessing from a BBF network via an RG (Residential Gateway). In the authentication process, the 3GPP UE, as an 802.1x customer service end, initiates an access authentication to the RG. At this moment, the RG, as an 802.1x authenticator and an RADIUS (Remote Authentication Dial In User Service) customer service end, initiates an authentication request to a BBF AAA (Authentication Authorization Accounting) server, with an authentication message in an RADIUS protocol or a Diameter protocol (an enhancement protocol of the RADIUS). In the address request process, an address request message initiated by the 3GPP UE makes a request for an IP address to a PDN-GW (Packet Data Network Gateway, or P-GW, or PGW) via a BNG (Broadband Network Gateway). Wherein an S2a session is established between the BNG and the PDN-GW, and is implemented by a GTP (GPRS (General Packet Radio Service) Tunneling Protocol) or a Proxy Mobile Internet Protocol (PMIP) tunnel.

It should be noted that the BNG is one kind of fixed network gateway. In some cases, the fixed network gateway may also be an IP Edge (IP Edge Equipment), or a BRAS (Broadband Remote Access Server). The following only takes the BNG as an example to introduce the establishment procedure of a session in a scenario supported by the BNG.

In the related technologies, each user BNG needs to establish an S2a session with the PDN-GW, and in order to support the scenario in the existing networks, all the BNG equipment need to be updated, and this will greatly affects the existing networks. In order to solve the problem, the fixed network access gateway (e.g., a TWAG (Trust WLAN Access Gateway)) is introduced. Refer to FIG. 1. FIG. 1 is an architecture diagram of a WLAN accessing an evolved packet network (EPC) and supporting strategy intercommunication according to the related technologies.

By introducing a fixed network access gateway TWAG, the problem of performing a large scale update on the BNG equipment is solved, and the influence on the existing network is maximally reduced. On the basis of the current updated network, refer to FIG. 2. FIG. 2 is a flowchart of a terminal accessing the EPC via the WLAN according to the related technologies. As shown in FIG. 2, the access of the terminal is performed in accordance with the following steps:

Step S201, the 3GPP UE sending an authentication protocol start (EAPoL-Start) message to the RG to perform authentication via the 802.1X protocol, wherein the UE is the client of the 802.1X, and the RG is the authenticator of the 802.1X.

Step S202, after receiving the EAPoL Start message sent by the UE, the RG sending an authentication protocol ID request (EAP Identity Request) to the UE, which is used for notifying the UE to report the user name; after receiving an EAP Identity Request message sent by the RG, the UE replying to the RG with an authentication protocol ID response (EAP Identity Response) message, wherein the message carries the user name; and then the RG encapsulating the received EAP Identity Response message into an authentication access request (RADIUS Access Request) message, and sending the RADIUS Access Request message to the BNG.

Step S203, the BNG, as an RADIUS Proxy, sending the RADIUS Access Request message received from the RG to a BBF AAA.

Step S204, the BBF AAA forwarding the RADIUS Access Request message received from the BNG to the 3GPP AAA according to the Network Address Identifier (NAI) of the UE. If the BBF network uses the RADIUS protocol, while the 3GPP network uses the DIAMETER protocol, then there exists a TA (Translation Agent) between the BBF AAA and the 3GPP AAA to perform protocol conversion.

Step S205, the BBF AAA sending to the TWAG an UE attachment request message which carries the subscription information of the UE.

Step S206, the TWAG sending a session creation request message to a PDN gateway of the 3GPP network, and the P-GW responding a session creation response to the TWAG, wherein in the session creation response responded to the TWAG, the PDN gateway sends an IP address (which may be an IPv4 address and/or an IPv6 address) allocated for the terminal by the PDN gateway to the TWAG.

Step S207, a tunnel being established between the TWAG and the PDN gateway through step S206.

Note: step S206 and step S207 assume that a GTP protocol is adopted between the TWAG and the PDN gateway. If a PMIPv6 (proxy mobile IP version 6) protocol is adopted between the TWAG and the PDN gateway, the message in step S206 should be a PBU (Proxy binding update) and PBA (Proxy binding Ack) message, and the tunnel corresponding to S207 should be a PMIPv6 tunnel.

Step S208, the TWAG replying to the BBF AAA with an UE attachment success message which carries the IP address of the UE.

Step S209, the BBF AAA sending to the BNG an UE authentication success response message which carries the IP address of the UE.

Step S210, at the same time, the BNG sending the authentication success response message of the UE to the RG according to the received UE address.

Step S211, the RG replying to the UE with the authentication success response message.

Step S212, the UE sending to the RG an address request message, for example, a DHCP Discover or Router Solicitation message (the RS message is optional).

Step S213, after receiving the address request message initiated by the UE, the BNG sending to the UE the IP address of the UE, for example, a DHCP Offer or RA message.

The terminal UE accesses the EPC (Evolved Packet Core) via the WLAN network through the steps above. According to the above-mentioned description, because the BNG and the TWAG have a many-to-one relationship, the address or domain name of the TWAG can be configured on the BNG. After the service data of the terminal UE arrives at the BNG, the BNG can send same to the TWAG by means of designating a route or equipment-level tunnel.

However, after the downlink service data packet of the terminal UE arrives at the TWAG, the TWAG cannot send the service data packet to the correct BNG (fixed network gateway) so as to send same to the correct terminal UE.

At present, there is no effective solution for the problem that the TWAG cannot send the service data packet to the correct fixed network gateway (e.g., a BNG) so as to send same to the correct terminal UE in the related technologies.

### SUMMARY

Embodiments of the present invention provide a data transmission method and device so as to at least solve the above-mentioned problem.

According to one aspect of the present invention, a data transmission method is provided, comprising: a trusted wireless local area network access gateway (TWAG) receives a fixed network gateway identity sent by a fixed network gateway; and the TWAG sends to the fixed network gateway, according to the fixed network gateway identity, a downlink data packet which is sent to the TWAG by a packet data network gateway (P-GW).

Preferably, the TWAG sends to the fixed network gateway, according to the fixed network gateway identity, the downlink data packet which is sent to the TWAG by the packet data network gateway (P-GW), comprising: after receiving the fixed network gateway identity, the TWAG establishes a corresponding relationship between the fixed network gateway identity and a tunnel between the TWAG and the P-GW; and after the downlink data packet arrives at the TWAG via the tunnel, the TWAG sends the downlink data packet to the fixed network gateway according to the corresponding relationship.

Preferably, the trusted wireless local area network access gateway (TWAG) receives the fixed network gateway identity sent by the fixed network gateway, comprising one of the following ways: the TWAG directly receives a first transmission message from the fixed network gateway, wherein the first transmission message carries the fixed network gateway identity of the fixed network gateway; and after an authentication, authorization and accounting server (BBF AAA) receives a second transmission message carrying the fixed network gateway identity and sent by the fixed network gateway, the TWAG receives a third transmission message sent by the BBF AAA, wherein the third transmission message carries the fixed network gateway identity.

Preferably, the fixed network gateway is one of the following: an IP edge equipment (IP Edge), a broadband network gateway equipment (BNG) and a broadband remote access server (BRAS).

Preferably, the first transmission message, second transmission message and third transmission message are all one of the following: an authentication message, an attachment request message, an access request message, a Radius message and a Diameter message.

According to another aspect of the present invention, a data transmission device is provided, which is located in the trusted wireless local area network access gateway (TWAG) and comprises: a receiving module which is configured to receive the fixed network gateway identity sent by the fixed network gateway; and a sending module which is configured to send to the fixed network gateway, according to the fixed network gateway identity, the downlink data packet which is sent to the trusted wireless local area network access gateway (TWAG) by the packet data network gateway (P-GW).

Preferably, the sending module comprises: an establishment unit which is configured to establish, after the receiving module receives the fixed network gateway identity, the corresponding relationship between the fixed network gateway identity and the tunnel between the TWAG and the P-GW; and a sending unit which is configured to send, after the downlink data packet arrives at the TWAG via the tunnel, the downlink data packet to the fixed network gateway according to the corresponding relationship.

Preferably, the receiving module comprises: a first receiving unit which is configured to directly receive the first transmission message from the fixed network gateway, wherein the first transmission message carries the fixed network gateway identity of the fixed network gateway; or a second receiving unit which is configured to receive, after the authentication, authorization and accounting server (BBF AAA) receives the second transmission message carrying the fixed network gateway identity and sent by the fixed network gateway, the third transmission message sent by the BBF AAA, wherein the third transmission message carries the fixed network gateway identity.

Preferably, the fixed network gateway is one of the following: an IP edge equipment (IP Edge), a broadband network gateway equipment (BNG) and a broadband remote access server (BRAS).

Preferably, the first transmission message, second transmission message and third transmission message are all one of the following: an authentication message, an attachment request message, an access request message, a Radius message and a Diameter message.

According to yet another aspect of the present invention, a data transmission method is provided, comprising: the fixed network gateway sends its own fixed network gateway identity to the trusted wireless local area network access gateway (TWAG); and after the TWAG receives the downlink data packet sent by the packet data network gateway (P-GW), the fixed network gateway receives the downlink data packet which is sent by the TWAG according to the fixed network gateway identity.

Preferably, the fixed network gateway receives the downlink data packet which is sent by the TWAG according to the fixed network gateway identity, comprising: the fixed network gateway receives the downlink data packet from the TWAG, wherein after establishing the corresponding relationship between the fixed network gateway identity and the tunnel between the TWAG and the P-GW, the TWAG sends the downlink data packet to the fixed network gateway according to the corresponding relationship.

Preferably, the fixed network gateway sends its own fixed network gateway identity to the trusted wireless local area network access gateway (TWAG), comprising one of the following ways: the fixed network gateway directly sends to the TWAG the first transmission message carrying the fixed network gateway identity of the fixed network gateway; and the fixed network gateway sends the second transmission message carrying the fixed network gateway identity to the authentication, authorization and accounting server (BBF AAA), and instructs the BBF AAA to send the third transmission message to the TWAG, wherein the transmission message carries the fixed network gateway identity.

Preferably, the fixed network gateway is one of the following: an IP edge equipment (IP Edge), a broadband network gateway equipment (BNG) and a broadband remote access server (BRAS).

Preferably, the first transmission message, second transmission message and third transmission message are all one of the following: an authentication message, an attachment request message, an access request message, a Radius message and a Diameter message.

According to a further aspect of the present invention, a data transmission device is provided, which is located in the fixed network gateway and comprises: the sending module which is configured to send the fixed network gateway identity of the fixed network gateway to the trusted wireless local area network access gateway (TWAG); and the receiving module which is configured to receive, after the TWAG receives the downlink data packet sent by the packet data network gateway (P-GW), the downlink data packet which is sent according to the fixed network gateway identity by the TWAG.

Preferably, the receiving module comprises a receiving unit which is configured to receive the downlink data packet from the TWAG, wherein after establishing the corresponding relationship between the fixed network gateway identity and the tunnel between the TWAG and the P-GW, the TWAG sends the downlink data packet to the fixed network gateway according to the corresponding relationship.

Preferably, the sending module comprises: a first sending unit which is configured to directly send to the TWAG the first transmission message carrying the fixed network gateway identity of the fixed network gateway; or a second sending unit which is configured to send the second transmission message carrying the fixed network gateway identity to the authentication, authorization and accounting server (BBF AAA), and instructs the BBF AAA to send the third transmission message to the TWAG, wherein the third transmission message carries the fixed network gateway identity.

Preferably, the fixed network gateway is one of the following: an IP edge equipment (IP Edge), a broadband network gateway equipment (BNG) and a broadband remote access server (BRAS).

Preferably, the first transmission message, second transmission message and third transmission message are all one of the following: an authentication message, an attachment request message, an access request message, a Radius message and a Diameter message.

Through the embodiments of the present invention, by the way of carrying a fixed network gateway identity of a fixed network gateway in an authentication message in an authentication process of a user terminal (UE) accessing an evolved packet network (EPC); and after establishing a corresponding relationship between the fixed network gateway identity and a tunnel between the TWAG and the packet data network gateway (PDN GW), transmitting service data according to the corresponding relationship, the problem that the TWAG cannot send the service data packet to the correct fixed network gateway so as to send same to the correct terminal UE in the related technologies is solved, the correct routing and forwarding of the downlink data service is realised, and thus the effect that smooth deployment of a terminal UE service is ensured is achieved.

### BRIEF DESCRIPTION OF THE DRAWINGS

Drawings, provided for further understanding of the disclosure and forming a part of the specification, are used to explain the disclosure together with embodiments of the disclosure rather than to limit the disclosure. In the drawings:

FIG. 1 is an architecture diagram of a WLAN accessing an evolved packet network (EPC) and supporting strategy intercommunication according to the related technologies;

FIG. 2 is a flowchart of a terminal accessing the EPC via the WLAN according to the related technologies;

FIG. 3 is a flowchart of a data transmission method according to the embodiment one of the present invention;

FIG. 4 is a flowchart of a data transmission method according to the embodiment two of the present invention;

FIG. 5 is a flowchart of a data transmission method according to the preferred embodiment one of the present invention;

FIG. 6 is a flowchart of a data transmission method according to the preferred embodiment two of the present invention;

FIG. 7 is a flowchart of a data transmission method according to the preferred embodiment three of the present invention;

FIG. 8 is a structural block diagram of a data transmission device according to the embodiment one of the present invention;

FIG. 9 is a structural block diagram of a data transmission device according to the preferred embodiment one of the present invention;

FIG. 10 is a structural block diagram of a data transmission device according to the embodiment two of the present invention; and

FIG. 11 is a structural block diagram of a data transmission device according to the preferred embodiment two of the present invention.

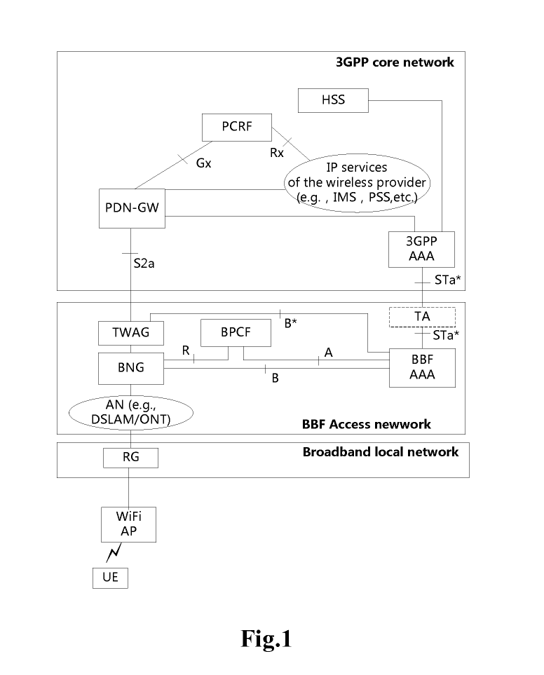

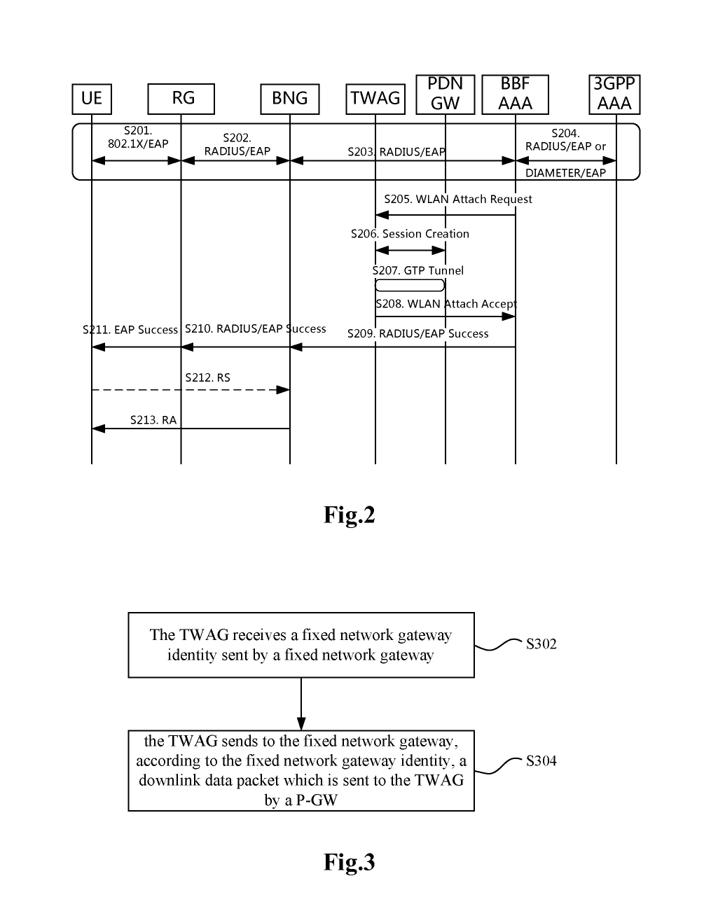

### DETAILED DESCRIPTION OF THE EMBODIMENTS

The disclosure is described below with reference to the accompanying drawings and embodiments in detail. Note that, the embodiments of the disclosure and the features of the embodiments can be combined with each other if there is no conflict.

FIG. 3 is a flowchart of a data transmission method according to the embodiment one of the present invention, as shown in FIG. 3, the method mainly comprises the following steps (step S302 to step S304):

step S302, a trusted wireless local area network access gateway (TWAG) receiving a fixed network gateway identity sent by a fixed network gateway; and

step S304, the TWAG sending to the fixed network gateway, according to the fixed network gateway identity, a downlink data packet which is sent to the TWAG by a packet data network gateway (P-GW).

In the present embodiment, step S304 can be implemented in this way: after receiving the fixed network gateway identity, the TWAG establishes a corresponding relationship between the fixed network gateway identity and a tunnel between the TWAG and the P-GW; and after the downlink data packet arrives at the TWAG via the tunnel, the TWAG sends the downlink data packet to the fixed network gateway according to the corresponding relationship.

In the present embodiment, step S304 can be implemented in one of the following ways: the TWAG directly receives a first transmission message from the fixed network gateway, wherein the first transmission message carries the fixed network gateway identity of the fixed network gateway; and after an authentication, authorization and accounting server (BBF AAA) receives a second transmission message carrying the fixed network gateway identity and sent by the fixed network gateway, the TWAG receives a third transmission message sent by the BBF AAA, wherein the third transmission message carries the fixed network gateway identity.

In the present embodiment, the fixed network gateway is one of the following: an IP edge equipment (IP Edge), a broadband network gateway equipment (BNG) and a broadband remote access server (BRAS).

In the present embodiment, the first transmission message, second transmission message and third transmission message are all one of the following: an authentication message, an attachment request message, an access request message, a Radius message and a Diameter message.

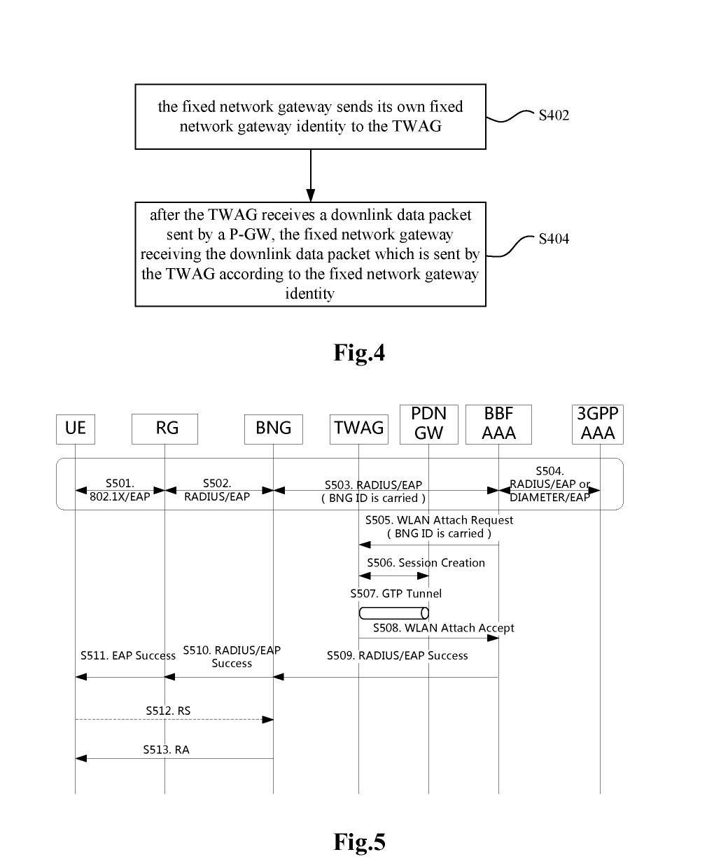

FIG. 4 is a flowchart of a data transmission method according to the embodiment two of the present invention, as shown in FIG. 4, the method mainly comprises the following steps (step S402 to step S404):

step S402, the fixed network gateway sending its own fixed network gateway identity to the trusted wireless local area network access gateway (TWAG); and

step S404, after the TWAG receives a downlink data packet sent by a packet data network gateway (P-GW), the fixed network gateway receiving the downlink data packet which is sent by the TWAG according to the fixed network gateway identity.

In step S404 of the present embodiment, when the fixed network gateway receives the downlink data packet which is sent by the TWAG according to the fixed network gateway identity, it can be implemented in this way: the fixed network gateway receives the downlink data packet from the TWAG, wherein after establishing the corresponding relationship between the fixed network gateway identity and the tunnel between the TWAG and the P-GW, the TWAG sends the downlink data packet to the fixed network gateway according to the corresponding relationship.

In the present embodiment, step S402 can be implemented in this way: the fixed network gateway directly sends to the TWAG the first transmission message carrying the fixed network gateway identity of the fixed network gateway; and the fixed network gateway sends the second transmission message carrying the fixed network gateway identity to the authentication, authorization and accounting server (BBF AAA), and instructs the BBF AAA to send the third transmission message to the TWAG, wherein the transmission message carries the fixed network gateway identity.

In the present embodiment, the fixed network gateway is one of the following: an IP edge equipment (IP Edge), a broadband network gateway equipment (BNG) and a broadband remote access server (BRAS).

In the present embodiment, the first transmission message, second transmission message and third transmission message are respectively one of the following: an authentication message, an attachment request message, an access request message, a Radius message and a Diameter message.

The above-mentioned data transmission method will be illustrated in detail below in combination with FIGS. 5 to 7, the preferred embodiment one, the preferred embodiment two and the preferred embodiment three.

### Embodiment One

In the present embodiment, in the access authentication process of a terminal UE, a BNG sends an ID (generally being an IP address, or an FQDN) of the BNG itself to a BBF AAA via an authentication message (a Radius message of the EAP authentication), and the BBF AAA sends the received BNG ID to a TWAG via an attachment request message (one step of the authentication message, the Radius message).

Because in the above-mentioned message, besides the BNG ID, there is also a terminal identifier, in addition, the attachment request message also triggers a subsequent establishment of a tunnel between the TWAG and the PDN gateway. Thus, at least a corresponding relationship between the BNG ID and “the tunnel between the TWAG and the PDN gateway” is established on the TWAG. Hence, after a service data packet arrives at the TWAG from the PDN gateway, the TWAG can know which BNG the data packet is routed to according to the above-mentioned corresponding relationship.

The TWAG can route the data to the BNG by adopting any method in the prior art. For example, an equipment-level tunnel exists between the TWAG and the BNG, then the tunnel can be used to perform the sending; or the TWAG designates a route, but the next hop must be a BNG; or the TWAG is triggered by the attachment request message to establish a dedicated tunnel for serving the UE with the BNG, and send the data packet to the BNG via the dedicated tunnel.

FIG. 5 is a flowchart of a data transmission method according to the preferred embodiment one of the present invention. As shown in FIG. 5, the data transmission process provided in the present embodiment comprises the following steps:

Step S501, the 3GPP UE sending an authentication protocol start (EAPoL-Start) message to the RG to perform authentication via the 802.1X protocol, wherein the UE is the client of the 802.1X, and the RG is the authenticator of the 802.1X.

Step S502, after receiving the EAPoL Start message sent by the UE, the RG sending an authentication protocol ID request (EAP Identity Request) to the UE, which is used for notifying the UE to report the user name; after receiving an EAP Identity Request message sent by the RG, the UE replying to the RG with an authentication protocol ID response (EAP Identity Response) message, wherein the message carries the user name; and then the RG encapsulating the received EAP Identity Response message into an authentication access request (RADIUS Access Request) message, and sending the RADIUS Access Request message to the BNG.

Step S503, the BNG, as an RADIUS Proxy, sending the RADIUS Access Request message received from the RG to a BBF AAA, and the BNG sending a BNG ID to the BBF AAA in the RADIUS Access Request message which is sent to the BBF AAA by proxy, or coordinating with the message.

Step S504, the BBF AAA forwarding the RADIUS Access Request message received from the BNG to the 3GPP AAA according to the Network Address Identifier (NAI) of the UE. If the BBF network uses the RADIUS protocol, while the 3GPP network uses the DIAMETER protocol, then there exists a TA (Translation Agent) between the BBF AAA and the 3GPP AAA to perform protocol conversion.

Step S505, the BBF AAA sending to the TWAG an UE attachment request message which carries the subscription information of the UE; and sending the BNG ID to the TWAG.

Step S506, the TWAG sending a session creation request message to a PDN gateway of the 3GPP network, and the P-GW responding a session creation response to the TWAG, wherein in the session creation response responded to the TWAG, the PDN gateway sends an IP address (which may be an IPv4 address and/or an IPv6 address) allocated for the terminal by the PDN gateway to the TWAG.

Thus, a corresponding relationship between the BNG ID and “the tunnel between the TWAG and the PDN gateway” is established on the TWAG. When the subsequent service runs smoothly, and after the downlink service data packet arrives at the TWAG from the PDN gateway, the TWAG can know which BNG the data packet is routed to according to the above-mentioned corresponding relationship.

Step S507, a tunnel being established between the TWAG and the PDN gateway through step S506.

It should be noted that step S506 and step S507 assume that a GTP protocol is adopted between the TWAG and the PDN gateway. If a PMIPv6 (proxy mobile IP version 6) protocol is adopted between the TWAG and the PDN gateway, the message in step S506 should be a PBU (Proxy binding update) and PBA (Proxy binding Ack) message, and the tunnel corresponding to S507 should be a PMIPv6 tunnel.

Step S508, the TWAG replying to the BBF AAA with an UE attachment success message which carries the IP address of the UE.

Step S509, the BBF AAA sending to the BNG an UE authentication success response message which carries the IP address of the UE.

Step S510, at the same time, the BNG sending the authentication success response message of the UE to the RG according to the received UE address.

Step S511, the RG replying to the UE with the authentication success response message.

Step S512, the UE sending to the RG an address request message, for example, a DHCP Discover or Router Solicitation message (the RS message is optional).

Step S513, after receiving the address request message initiated by the UE, the BNG sending to the UE the IP address of the UE, for example, a DHCP Offer or RA message.

### Embodiment Two

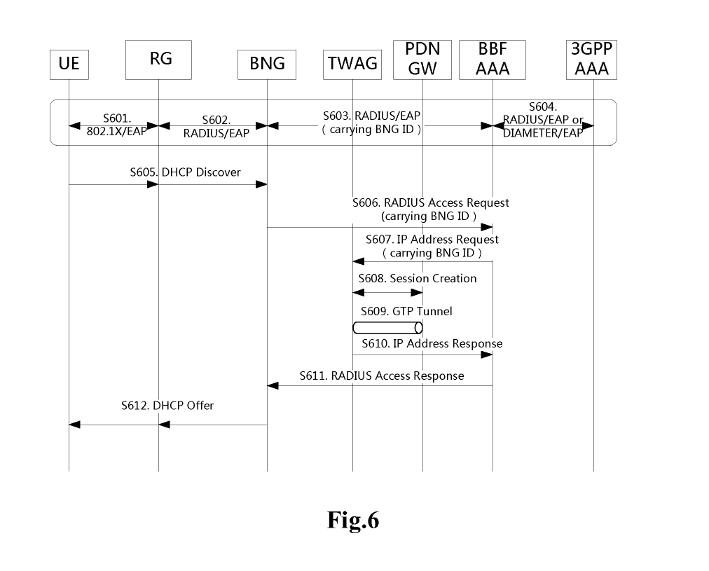

In the present embodiment, the operations of user authentication and IPv4 address allocation of another type of 3GPP UE accessing from a fixed network may be taken as a basis for introducing how to realise the data transmission method. Compared with the embodiment one, the difference between the two the embodiment lies in different sending timings and message bodies for transmitting a BNG ID message. FIG. 6 is a flowchart of a data transmission method according to the preferred embodiment two of the present invention. As shown in FIG. 6, the data transmission process provided in the present embodiment comprises the following steps:

Step S601, the 3GPP UE sending an authentication protocol start (EAPoL-Start) message to the RG to perform authentication via the 802.1X protocol, wherein the UE is the client of the 802.1X, and the RG is the authenticator of the 802.1X.

Step S602, after receiving the EAPoL Start message sent by the UE, the RG sending an authentication protocol ID request (EAP Identity Request) to the UE, which is used for notifying the UE to report the user name; after receiving an EAP Identity Request message sent by the RG, the UE replying to the RG with an authentication protocol ID response (EAP Identity Response) message, wherein the message carries the user name; and then the RG encapsulating the received EAP Identity Response message into an authentication access request (RADIUS Access Request) message, and sending the RADIUS Access Request message to the BNG.

Step S603, the BNG, as an RADIUS Proxy, sending the RADIUS Access Request message received from the RG to a BBF AAA.

Step S604, the BBF AAA forwarding the RADIUS Access Request message received from the BNG to the 3GPP AAA according to the Network Address Identifier (NAI) of the UE. If the BBF network uses the RADIUS protocol, while the 3GPP network uses the DIAMETER protocol, then there exists a TA (Translation Agent) between the BBF AAA and the 3GPP AAA to perform protocol conversion.

If the authentication of the 3GPP UE in the 3GPP AAA succeeds, then the 3GPP AAA replying to the BBF AAA with an authentication success response message, and further more, the BBF replying to the BNG, the BNG replying to the RG, and the RG replying to the UE.

Step S605, the UE sending a DHCP Discover message to request an IPv4 address; and if the RG is of a route-type, the RG relaying the message to the BNG.

Step S606, the BNG sending the RADIUS Access Request to the BBF AAA to request an address for the UE, wherein the RADIUS Access Request carries the MAC address of the UE; and the BNG sending a BNG ID to the BBF AAA in the RADIUS Access Request message, or coordinating with the message.

Step S607, after receiving the message sent by the BNG, the BBF AAA sending to the TWAG an IP address request message which carries the subscription information of the UE; and sending the BNG ID to the TWAG.

Step S608, the TWAG sending a session creation request message to a PDN gateway of the 3GPP network, and the P-GW responding a session creation response to the TWAG, wherein in the session creation response responded to the TWAG, the PDN gateway sends an IP address (which may be an IPv4 address and/or an IPv6 address) allocated for the terminal by the PDN gateway to the TWAG.

Thus, a corresponding relationship between the BNG ID and “the tunnel between the TWAG and the PDN gateway” is established on the TWAG. When the subsequent service runs smoothly, and after the downlink service data packet arrives at the TWAG from the PDN gateway, the TWAG can know which BNG the data packet is routed to according to the above-mentioned corresponding relationship.

Step S609, a tunnel being established between the TWAG and the PDN gateway through step S608.

It should be noted that step S608 and step S609 assume that a GTP protocol is adopted between the TWAG and the PDN gateway. If a PMIPv6 (proxy mobile IP version 6) protocol is adopted between the TWAG and the PDN gateway, the message in step S606 should be a PBU (Proxy binding update) and PBA (Proxy binding Ack) message, and the tunnel corresponding to S607 should be a PMIPv6 tunnel.

Step S610, the TWAG replying to the BBF AAA with an IP address response message which carries the IP address of the UE.

Step S611, the BBF AAA replying to the BNG with a response message (a RADIUS Access Response message) which carries the IP address of the UE.

Step S612, the BNG sending the IPv4 address to the UE.

### Embodiment Three

In the present embodiment, it is based on another assumption, that is to say, in the access authentication process of a terminal UE, and in the process that a TWAG serves as an intermediate proxy network element to transmit an authentication message, and a BNG sends an ID (generally being an IP address, or an FQDN) of the BNG itself to a BBF AAA via the authentication message (a Radius message of the EAP authentication), the message is forwarded via the TWAG, and the BNG ID is acquired by the TWAG.

Because in the above-mentioned message, besides the BNG ID, there is also a terminal identifier, in addition, the attachment request message also triggers a subsequent establishment of a tunnel between the TWAG and the PDN gateway. Thus, at least a corresponding relationship between the BNG ID and “the tunnel between the TWAG and the PDN gateway” is established on the TWAG. Hence, after a service data packet arrives at the TWAG from the PDN gateway, the TWAG can know which BNG the data packet is routed to according to the above-mentioned corresponding relationship.

The TWAG can route the data to the BNG by adopting any method in the prior art. For example, an equipment-level tunnel exists between the TWAG and the BNG, then the tunnel can be used to perform the sending; or the TWAG designates a route, but the next hop must be a BNG; or the TWAG is triggered by the attachment request message to establish a dedicated tunnel for serving the UE with the BNG, and send the data packet to the BNG via the dedicated tunnel.

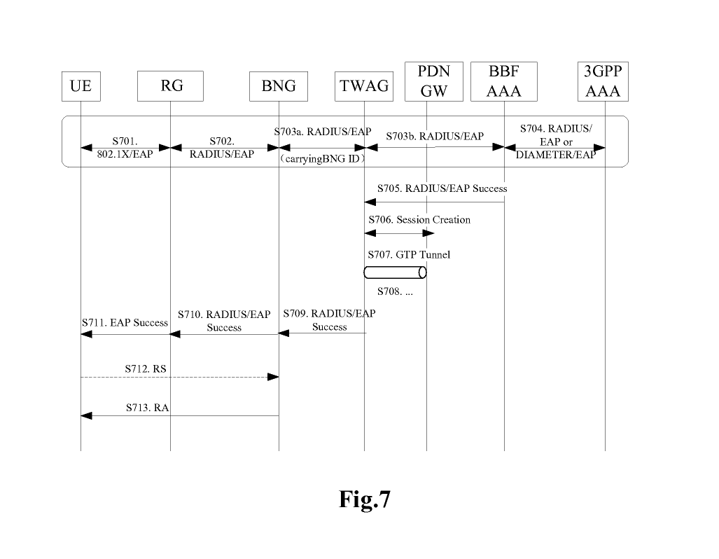

FIG. 7 is a flowchart of a data transmission method according to the preferred embodiment three of the present invention. As shown in FIG. 7, the data transmission method provided in the present embodiment comprises the following steps:

Step S701, the 3GPP UE sending an authentication protocol start (EAPoL-Start) message to the RG to perform authentication via the 802.1X protocol, wherein the UE is the client of the 802.1X, and the RG is the authenticator of the 802.1X.

Step S702, after receiving the EAPoL Start message sent by the UE, the RG sending an authentication protocol ID request (EAP Identity Request) to the UE, which is used for notifying the UE to report the user name; after receiving an EAP Identity Request message sent by the RG, the UE replying to the RG with an authentication protocol ID response (EAP Identity Response) message, wherein the message carries the user name; and then the RG encapsulating the received EAP Identity Response message into an authentication access request (RADIUS Access Request) message, and sending the RADIUS Access Request message to the BNG.

Steps S703a and S703b, the BNG and the TWAG, as the RADIUS Proxies, sending the RADIUS Access Request message received from the RG to a BBF AAA; and the BNG carrying a BNG ID in the RADIUS Access Request message, or coordinating with the message, which is intermediately intercepted and recorded by the TWAG; and finally the message being transmitted to the BBF AAA.

Step S704, the BBF AAA forwarding the RADIUS Access Request message received from the BNG to the 3GPP AAA according to the Network Address Identifier (NAI) of the UE. If the BBF network uses the RADIUS protocol, while the 3GPP network uses the DIAMETER protocol, then there exists a TA (Translation Agent) between the BBF AAA and the 3GPP AAA to perform protocol conversion.

Step S705, the BBF AAA sending a Radius/EAP success message to the TWAG.

Step S706, the TWAG sending a session creation request message to a PDN gateway of the 3GPP network, and the P-GW responding a session creation response to the TWAG, wherein in the session creation response responded to the TWAG, the PDN gateway sends an IP address (which may be an IPv4 address and/or an IPv6 address) allocated for the terminal by the PDN gateway to the TWAG.

Thus, a corresponding relationship between the BNG ID and “the tunnel between the TWAG and the PDN gateway” is established on the TWAG. When the subsequent service runs smoothly, and after the downlink service data packet arrives at the TWAG from the PDN gateway, the TWAG can know which BNG the data packet is routed to according to the above-mentioned corresponding relationship.

Step S707, a tunnel being established between the TWAG and the PDN gateway through step S706.

It should be noted that step S706 and step S707 assume that a GTP protocol is adopted between the TWAG and the PDN gateway. If a PMIPv6 (proxy mobile IP version 6) protocol is adopted between the TWAG and the PDN gateway, the message in step S706 should be a PBU (Proxy binding update) and PBA (Proxy binding Ack) message, and the tunnel corresponding to S707 should be a PMIPv6 tunnel.

Step S708 is omitted.

Step S709, the BBF AAA sending to the BNG an UE authentication success response message which carries the IP address of the UE.

Step S710, at the same time, the BNG sending the authentication success response message of the UE to the RG according to the received UE address.

Step S711, the RG replying to the UE with the authentication success response message.

Step S712, the UE sending to the RG an address request message, for example, a DHCP Discover or Router Solicitation message (the RS message is optional).

Step S713, after receiving the address request message initiated by the UE, the BNG sending to the UE the IP address of the UE, for example, a DHCP Offer or RA message.

By using the data transmission method, which is provided in the above-mentioned embodiment, that a fixed network gateway identity of a fixed network gateway is carried in an authentication message in an authentication process of a user terminal (UE) accessing an evolved packet network (EPC); and after establishing a corresponding relationship between the fixed network gateway identity and a tunnel between the TWAG and the packet data network gateway (PDN GW), the service data is transmitted according to the corresponding relationship, the problem that the TWAG cannot send the service data packet to the correct fixed network gateway so as to send same to the correct terminal UE in the related technologies is solved.

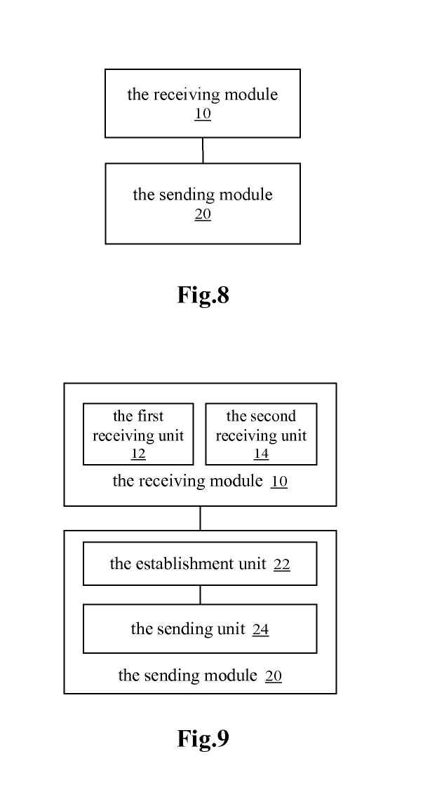

FIG. 8 is a structural block diagram of a data transmission device according to the embodiment one of the present invention, wherein the device is used for realising the data transmission method provided in the above-mentioned embodiment and is located in the trusted wireless local area network access gateway (TWAG). As shown in FIG. 8, the device mainly comprises a receiving module 10 and a sending module 20. Wherein the receiving module 10 is configured to receive the fixed network gateway identity sent by the fixed network gateway; and the sending module 20 is connected to the receiving module 10 and is configured to send to the fixed network gateway, according to the fixed network gateway identity, the downlink data packet which is sent to the trusted wireless local area network access gateway (TWAG) by the packet data network gateway (P-GW).

FIG. 9 is a structural block diagram of a data transmission device according to the preferred embodiment one of the present invention. As shown in FIG. 9, in the present invention, the authentication message is used when the evolved packet network (EPC) performs access authentication on the user terminal (UE) in the authentication process of the UE accessing the EPC.

In the device provided in the preferred embodiment, the sending module 20 comprises: an establishment unit 22 which is configured to establish, after the receiving module receives the fixed network gateway identity, the corresponding relationship between the fixed network gateway identity and the tunnel between the TWAG and the P-GW; and a sending unit 24 which is connected to the establishment unit 22 and is configured to send, after the downlink data packet arrives at the TWAG via the tunnel, the downlink data packet to the fixed network gateway according to the corresponding relationship.

In the device provided in the preferred embodiment, the receiving module 10 comprises: a first receiving unit 12 which is configured to directly receive the first transmission message from the fixed network gateway, wherein the first transmission message carries the fixed network gateway identity of the fixed network gateway; or a second receiving unit 14 which is configured to receive, after the authentication, authorization and accounting server (BBF AAA) receives the second transmission message carrying the fixed network gateway identity and sent by the fixed network gateway, the third transmission message sent by the BBF AAA, wherein the third transmission message carries the fixed network gateway identity.

In the present embodiment, the fixed network gateway is one of the following: an IP edge equipment (IP Edge), a broadband network gateway equipment (BNG) and a broadband remote access server (BRAS).

In the present embodiment, the first transmission message, second transmission message and third transmission message are all one of the following: an authentication message, an attachment request message, an access request message, a Radius message and a Diameter message.

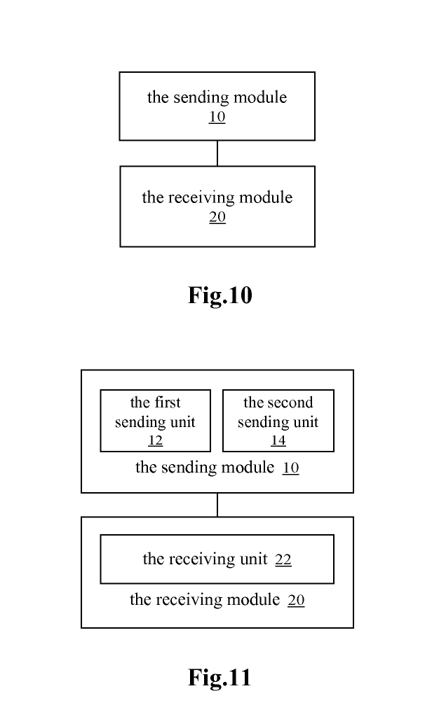

FIG. 10 is a structural block diagram of a data transmission device according to the embodiment two of the present invention, wherein the device is used for realising the data transmission method provided in the above-mentioned embodiment and is located in the fixed network gateway. As shown in FIG. 10, the device mainly comprises: a sending module 10 which is configured to send the fixed network gateway identity of the fixed network gateway to the trusted wireless local area network access gateway (TWAG); and a receiving module 20 which is configured to receive, after the TWAG receives the downlink data packet sent by the packet data network gateway (P-GW), the downlink data packet which is sent according to the fixed network gateway identity by the TWAG.

FIG. 11 is a structural block diagram of a data transmission device according to the preferred embodiment two of the present invention. As shown in FIG. 11, in the present invention, the authentication message is used when the evolved packet network (EPC) performs access authentication on the user terminal (UE) in the authentication process of the UE accessing the EPC.

In the device provided in the preferred embodiment, the receiving module 20 comprises a receiving unit 22 which is configured to receive the downlink data packet from the TWAG, wherein after establishing the corresponding relationship between the fixed network gateway identity and the tunnel between the TWAG and the P-GW, the TWAG sends the downlink data packet to the fixed network gateway according to the corresponding relationship.

In the device provided in the preferred embodiment, the sending module 10 comprises: a first sending unit 12 which is configured to directly send to the TWAG the first transmission message carrying the fixed network gateway identity of the fixed network gateway; or a second sending unit 14 which is configured to send the second transmission message carrying the fixed network gateway identity to the authentication, authorization and accounting server (BBF AAA), and instructs the BBF AAA to send the third transmission message to the TWAG, wherein the third transmission message carries the fixed network gateway identity.

In the present embodiment, the fixed network gateway is one of the following: an IP edge equipment (IP Edge), a broadband network gateway equipment (BNG) and a broadband remote access server (BRAS).

In the present embodiment, the first transmission message, second transmission message and third transmission message are all one of the following: an authentication message, an attachment request message, an access request message, a Radius message and a Diameter message.

By using the data transmission device, which is provided in the above-mentioned embodiment, that a fixed network gateway identity of a fixed network gateway is carried in an authentication message in an authentication process of a user terminal (UE) accessing an evolved packet network (EPC); and after establishing a corresponding relationship between the fixed network gateway identity and a tunnel between the TWAG and the packet data network gateway (PDN GW), the service data is transmitted according to the corresponding relationship, the problem that the TWAG cannot send the service data packet to the correct fixed network gateway so as to send same to the correct terminal UE in the related technologies is solved.

From the description above, it can be seen that the disclosure achieves the following technique effects:

By the way of carrying a fixed network gateway identity of a fixed network gateway in an authentication message in an authentication process of a user terminal (UE) accessing an evolved packet network (EPC); and after establishing a corresponding relationship between the fixed network gateway identity and a tunnel between the TWAG and the packet data network gateway (PDN GW), transmitting service data according to the corresponding relationship, the problem that the TWAG cannot send the service data packet to the correct fixed network gateway so as to send same to the correct terminal UE in the related technologies is solved, the correct routing and forwarding of the downlink data service is realised, and thus the effect that smooth deployment of a terminal UE service is ensured is achieved.

Apparently, those skilled in the art shall understand that the above modules and steps of the present invention can be realized by using general purpose calculating device, can be integrated in one calculating device or distributed on a network which consists of a plurality of calculating devices, and alternatively they can be realized by using the executable program code of the calculating device, so that consequently they can be stored in the storing device and executed by the calculating device, in some cases, can perform the shown or described step in sequence other than herein, or they are made into integrated circuit module respectively, or a plurality of modules or steps thereof are made into one integrated circuit module. In this way, the disclosure is not restricted to any particular hardware and software combination.

The descriptions above are only the preferable embodiment of the disclosure, which are not used to restrict the disclosure, for those skilled in the art, the disclosure may have various changes and variations. Any amendments, equivalent substitutions, improvements, etc. within the principle of the disclosure are all included in the scope of the protection of the disclosure.

1. A method for transmitting data, comprising:
a trusted WLAN access gateway (TWAG) receiving a fixed network gateway identity sent by a fixed network gateway; and
the TWAG sending to the fixed network gateway, according to the fixed network gateway identity, a downlink data packet which is sent to the TWAG by a packet data network gateway (P-GW).

2. The method according to claim 1, wherein the TWAG sends to the fixed network gateway, according to the fixed network gateway identity, the downlink data packet which is sent to the TWAG by the packet data network gateway (P-GW), comprising:
after receiving the fixed network gateway identity, the TWAG establishing a corresponding relationship between the fixed network gateway identity and a tunnel between the TWAG and the P-GW; and
after the downlink data packet arrives at the TWAG via the tunnel, the TWAG sending the downlink data packet to the fixed network gateway according to the corresponding relationship.

3. The method according to claim 1, wherein the TWAG receives the fixed network gateway identity sent by the fixed network gateway, comprising one of the following ways:
the TWAG directly receiving a first transmission message from the fixed network gateway, wherein the first transmission message carries the fixed network gateway identity of the fixed network gateway; and
after an authentication, authorization and accounting server (BBF AAA) receives a second transmission message carrying the fixed network gateway identity and sent by the fixed network gateway, the TWAG receiving a third transmission message sent by the BBF AAA, wherein the third transmission message carries the fixed network gateway identity.

4. The method according to claim 3, wherein the fixed network gateway is one of the following:
an IP edge equipment (IP Edge), a broadband network gateway equipment (BNG) and a broadband remote access server (BRAS).

5. The method according to claim 4, wherein the first transmission message, second transmission message and third transmission message are respectively one of the following:
an authentication message, an attachment request message, an access request message, a Radius message and a Diameter message.

6. A device for transmitting data, the device is located in a trusted WLAN access gateway (TWAG), and the device comprises:
a receiving module, configured to receive a fixed network gateway identity sent by a fixed network gateway; and
a sending module, configured to send to the fixed network gateway, according to the fixed network gateway identity, a downlink data packet which is sent to the TWAG by a packet data network gateway (P-GW).

7. The device according to claim 6, wherein the sending module comprises:
an establishment unit, configured to establish, after the receiving module receives the fixed network gateway identity, a corresponding relationship between the fixed network gateway identity and a tunnel between the TWAG and the P-GW; and
a sending unit, configured to send, after the downlink data packet arrives at the TWAG via the tunnel, the downlink data packet to the fixed network gateway according to the corresponding relationship.

8. The device according to claim 6, wherein the receiving module comprises:
a first receiving unit, configured to directly receive a first transmission message from the fixed network gateway, wherein the first transmission message carries the fixed network gateway identity of the fixed network gateway; or
a second receiving unit, configured to receive, after an authentication, authorization and accounting server (BBF AAA) receives a second transmission message carrying the fixed network gateway identity and sent by the fixed network gateway, a third transmission message sent by the BBF AAA, wherein the third transmission message carries the fixed network gateway identity.

9. The device according to claim 8, wherein the fixed network gateway is one of the following:
an IP edge equipment (IP Edge), a broadband network gateway equipment (BNG) and a broadband remote access server (BRAS).

10. The device according to claim 9, wherein the first transmission message, second transmission message and third transmission message are respectively one of the following:
an authentication message, an attachment request message, an access request message, a Radius message and a Diameter message.

11. A method for transmitting data, comprising:
a fixed network gateway sending its own fixed network gateway identity to a trusted WLAN access gateway (TWAG); and
after the TWAG receives a downlink data packet sent by a packet data network gateway (P-GW), the fixed network gateway receiving the downlink data packet which is sent by the TWAG according to the fixed network gateway identity.

12. The method according to claim 11, wherein the fixed network gateway receives the downlink data packet which is sent by the TWAG according to the fixed network gateway identity, comprising:
the fixed network gateway receiving the downlink data packet from the TWAG, wherein after establishing a corresponding relationship between the fixed network gateway identity and a tunnel between the TWAG and the P-GW, the TWAG sending the downlink data packet to the fixed network gateway according to the corresponding relationship.

13. The method according to claim 11, wherein the fixed network gateway sends its own fixed network gateway identity to the TWAG, comprising one of the following ways:
the fixed network gateway directly sending to the TWAG a first transmission message carrying the fixed network gateway identity of the fixed network gateway; and
the fixed network gateway sending a second transmission message carrying the fixed network gateway identity to an authentication, authorization and accounting server (BBF AAA), and instructing the BBF AAA to send a third transmission message to the TWAG, wherein the transmission message carries the fixed network gateway identity.

14. The method according to claim 13, wherein the fixed network gateway is one of the following:
an IP edge equipment (IP Edge), a broadband network gateway equipment (BNG) and a broadband remote access server (BRAS).

15. The method according to claim 14, wherein the first transmission message, second transmission message and third transmission message are respectively one of the following:
an authentication message, an attachment request message, an access request message, a Radius message and a Diameter message.

16. A device for transmitting data, the device is located in a fixed network gateway, and the device comprises:
a sending module, configured to send a fixed network gateway identity of the fixed network gateway to a trusted WLAN access gateway (TWAG); and
a receiving module, configured to receive, after the TWAG receives a downlink data packet sent by a packet data network gateway (P-GW), the downlink data packet which is sent according to the fixed network gateway identity by the TWAG.

17. The device according to claim 16, wherein the receiving module comprises:
a receiving unit, configured to receive the downlink data packet from the TWAG, wherein after establishing a corresponding relationship between the fixed network gateway identity and a tunnel between the TWAG and the P-GW, the TWAG sends the downlink data packet to the fixed network gateway according to the corresponding relationship.

18. The device according to claim 16, wherein the sending module comprises:
a first sending unit, configured to directly send to the TWAG a first transmission message carrying the fixed network gateway identity of the fixed network gateway; or
a second sending, configured to send a second transmission message carrying the fixed network gateway identity to an authentication, authorization and accounting server (BBF AAA), and instructs the BBF AAA to send a third transmission message to the TWAG, wherein the third transmission message carries the fixed network gateway identity.

19. The device according to claim 18, wherein the fixed network gateway is one of the following:
an IP edge equipment (IP Edge), a broadband network gateway equipment (BNG) and a broadband remote access server (BRAS).

20. The device according to claim 19, wherein the first transmission message, second transmission message and third transmission message are respectively one of the following:
an authentication message, an attachment request message, an access request message, a Radius message and a Diameter message.
